(19) United States
(12) Patent Application Publication
(10) Pub. No.: US 2006/0001419 A1
(43) Pub. Date: Jan. 5, 2006

(54) Angular sensor and safety mechanism therefor

(75) Inventor: Hau Chung Lam, Hong Kong (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Grand Door Development Limited, Hong Kong (CN)

(21) Appl. No.: 10/882,384

(22) Filed: Jul. 2, 2004

(51) Int. Cl. G01B 7/14

(52) U.S. Cl. 324/207.25; 324/207.17

(57) ABSTRACT

An inductive angular sensor is disclosed as including a first part and a second part which are swivellably movable relative to each other, in which the first part includes a primary coil energizable to generate a voltage and two secondary coils each on a side of the primary coil for sensing the voltage generated by the primary coil, and a channel runs through the primary and secondary coils, and the second part includes a rotor mounted with two wires, such that during relative swivelling movement between the first and second parts, the wires reciprocate in the channel, and when the angle of rotation between the first and second parts is within a pre-determined range about a zero position, the wires are out of said primary coil. A sensing device is also disclosed as including an angular sensor and a zero position detector, in which the angular sensor includes a first part and a second part which are swivellably movable relative to each other, and the zero position detector has a logic level output when the angle of rotation between the first and second parts is within a pre-determined range about a pre-defined zero position.

This invention relates to an angular sensor and, in particular, such a sensor for contactless determination of a rotary angle, and a safety mechanism for use in conjunction with an angular sensor.

### BACKGROUND OF THE INVENTION

There has been a constant need for position sensors for use in such commercial applications as electrical scooters, wheelchairs and joysticks, to name just a few. Existing sensors include contact type potentiometer sensors, which are known to be wanting in reliability.

It is thus an object of the present invention to provide an inductive angular sensor in which the aforesaid shortcomings are mitigated.

It is a further object of the present invention to provide an inductive angular sensor which is both reliable and of a relatively low cost.

It is a yet further object of the present invention to provide an angular sensor with a built-in safety mechanism.

### SUMMARY OF THE INVENTION

According to a first aspect of the present invention, there is provided an inductive angular sensor including a first part and a second part which are swivellably movable relative to each other, wherein said first part includes a primary coil energizable to generate a voltage and two secondary coils each on a side of said primary coil and adapted to sense the voltage generated by said primary coil, wherein a channel runs through said primary coil and said two secondary coils, wherein said second part includes a body member mounted with at least one wire member, wherein during relative swivelling movement between said first and second parts, said at least one metallic wire member reciprocates in said channel, and wherein when the angle of rotation between said first and second parts is within a pre-determined range about a pre-defined zero position, said at least one metallic wire member is out of said primary coil.

According to a second aspect of the present invention, there is provided a sensing device including an angular sensor and a zero position detector, wherein said angular sensor includes a first part and a second part which are swivellably movable relative to each other, and wherein said zero position detector is adapted to have a logic level output when the angle of rotation between said first and second parts is within a pre-determined range about a pre-defined zero position.

### BRIEF DESCRIPTION OF THE DRAWINGS

Preferred embodiments of the present invention will now be described, by way of examples only, with reference to the accompanying drawings, in which:

FIG. 1 is a transverse sectional view of an inductive angular sensor according to a first preferred embodiment of the present invention;

FIG. 2 is a circuit diagram of the sensor shown in FIG. 1;

FIG. 3A is a schematic circuit diagram of a safety mechanism according to the present invention as used in conjunction with an inductive angular sensor;

FIG. 3B is an alternative switch arrangement for use in the safety mechanism shown in FIG. 3A;

FIG. 4A shows a front view of a position detecting mechanism of an inductive angular sensor according to a further preferred embodiment of the present invention;

FIG. 4B is a side view of the position detecting mechanism shown in FIG. 4A;

FIG. 4C is a partial schematic circuit diagram of the position detecting mechanism shown in FIG. 4A;

FIG. 4D shows a front view of an alternative arrangement of a position detecting mechanism of an inductive angular sensor according to a yet further preferred embodiment of the present invention; and

FIG. 4E is a side view of the position detecting mechanism shown in FIG. 4D.

### DETAILED DESCRIPTION OF THE PREFERRED EMBODIMENTS

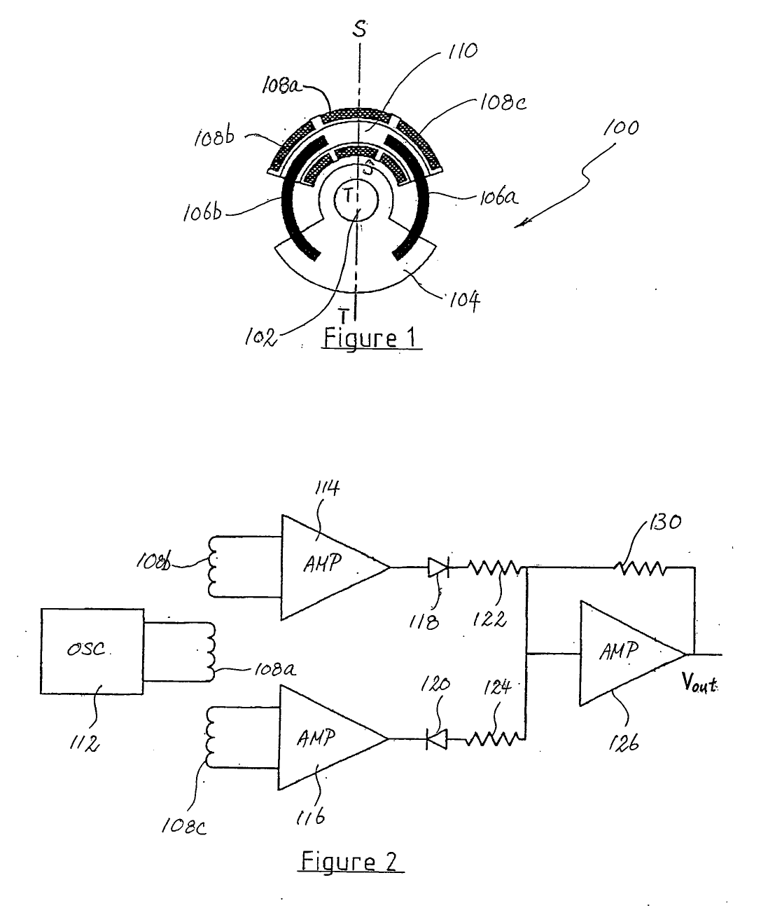

An inductive angular sensor according to a first preferred embodiment of the present invention is shown in FIG. 1, and generally designated as 100. A spindle 102, which is attached to a device (not shown) the angle of which is to be measured, is fixedly secured with a rotor 104. The rotor 104 supports two arcuate metal wires 106a, 106b, each on one side thereof, for simultaneous swivelling movement about the longitudinal axis of the spindle 102. It should be understood that the invention may also work with a rotor with only one arcuate wire, e.g. in which the lower ends of the wires 106a, 106b are joined with each other.

The metal wires 106a, 106b should preferably be made of a metal of a high magnetic permeability and low permanence, e.g. soft iron or silicon iron. With a high magnetic permeability, a high magnetic flux will be generated by only a small relative movement, thus enhancing the sensitivity of the sensor. Permanence is also called coercivity. A permanent magnet has a high permanence as magnetism is retained effectively, whereas a soft iron has a low permanence.

A primary magnetic coil 108a and two secondary magnetic coils 108b, 108c are arranged as a Linear Voltage Differential Transformer, in which the primary coil 108a is positioned between the two secondary coils 108b, 108c. An arcuate channel 110, which is of essentially the same radius of curvature as the iron wires 106a, 106b, runs through the three magnetic coils 108a, 108b, 108c. As the spindle 102 swivels about its longitudinal axis, the iron wires 106a, 106b will swivel, thus reciprocate, within the channel 110, and thus within and relative to the coils 108a, 108b, 108c. In the “zero position”, as shown in FIG. 1, the centre line S-S of the primary coil 108a is aligned with the centre line T-T of the rotor 104. However, as the rotor 104 rotates relative to the coils 108a, 108b, 108c, the angle of rotation (i.e. the angle between the lines S-S and T-T) will vary. It should also noted that when in the “zero position” as shown in FIG. 1, or when the angle of rotation is within a narrow range about this zero position, the wires 106a, 106b are positioned within the two secondary coils 108b, 108c, but out of the primary coil 108a.

As the primary coil 108a, also called “exciting coil”, is energized by a sinusoidal oscillator, to be discussed below, the secondary coils 108b, 108c, also called “detecting coils”, act as detectors. The primary coil 108a, so energized, will generate magnetic fluxes which are detected by the secondary coils 108b, 108c. When the spindle 102 swivels, which will bring about simultaneous swivelling movement of the rotor 104 and the wires 106a, 106b carried by it, the fluxes coupled to the secondary coils 108b, 108c will increase or decrease, in which the outputs from the secondary coils 108b, 108c will be proportional to the angle of rotation of the wires 106a, 106b (and thus the rotor 104) relative to the coils 108a, 108b, 108c.

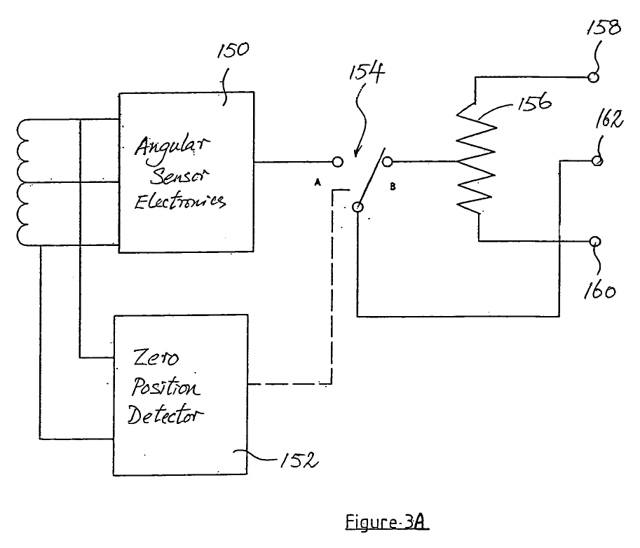

Referring now to FIG. 2, a sinusoidal oscillator 112 energizes the primary coil 108a to generate corresponding sinusoidal magnetic fluxes, which are detected by the secondary coils 108b, 108c. The signals from the secondary coils 108b, 108c are respectively amplified by an amplifier 114, 116. Signals from the coil 108b will generate a positive voltage, through rectification by a diode 118, whereas signals from the coil 108c will generate a negative voltage, through rectification by a diode 120. The two voltages will then be summed up, by resistors 122, 124 and an amplifier 126, as Vₒᵤₜ, which is proportion to the angle of rotation of the wires 106a, 106b (and thus the rotor 104) relative to the stationary coils 108a, 108b, 108c. A resistor 130 is also provided between the resistor 122 and the output of the amplifier 126.

It can be seen that the use of two iron wires in a rotary voltage detector transformer simplifies the construction of the sensor. It is found in practice that, as compared with conventional arrangement, it is easier to assemble the wires 106a, 106b in the sensor. In addition, the use of operational amplifiers eliminates the necessity of using a phase detector circuit, as in the conventional design.

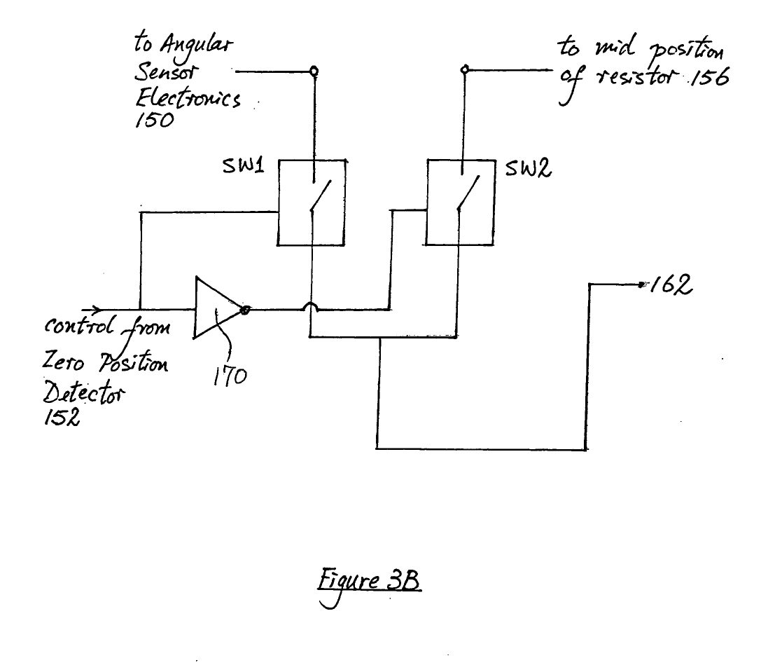

In devices such as electrical wheelchairs for disabled persons, it is important that any defects in the circuitry will not affect the zero position output. According to a further preferred embodiment of this invention, an inductive angular sensor with a safety mechanism is provided. It should be understood that a safety mechanism according to the present invention may be incorporated in various types of contactless potentiometers or rotary sensors, including, but not limited to, inductive angular sensors and optical sensors, although it will henceforth be explained in the context of an inductive angular sensor. As shown in FIG. 3A, the output signals from the detecting coils are inputted to an Angular Sensor Electronics 150, e.g. the inductive angular sensor 100 discussed above, where such are processed to produce an output which is proportional to the angular position of the rotor 104 relative to the coils 108a, 108b, 108c.

The coil signals are also fed into a Zero Position Detector 152. When the wires 106a, 106b are in the centre position, i.e. as shown in FIG. 1, the differential signals will be or very close to zero. The circuit of the Zero Position Detector 152 is designed to have a logic level output when the wires 106a, 106b are within a small angle, called the “dead zone”, around the centre position. The Angular Sensor Electronics 150 may be designed to output linear signals only when the dead zone angle is exceeded.

The output from the Zero Position Detector 152 is used for controlling a switch 154, so that at the zero dead zone, the switch 154 is at position B. The output (now shown at 162) would be connected to the centre of a fixed resistor 156, and divided substantially equally for output by two resistor terminals 158, 160 respectively. On the other hand, when the sensor 100 rotates outside of the dead zone, the switch 154 will be switched to position A, in which case its position can be controlled by the Angular Sensor Electronics 150. Thus, if either of the Angular Sensor Electronics 150 or the Zero Position Detector 152 is defective, the output will still be safe at the mid position. Since the chance of both the Angular Sensor Electronics 150 and the Zero Position Detector 152 failing at the same time is small, the control is very safe and reliable.

The switch 154 shown in FIG. 3A is a mechanical single pole double throw relay. In practice, although a mechanical relay is a relatively simple arrangement, such is of a limited life time. The switch may alternatively be constructed of electro-magnetically controlled reed switches. Reed switches may be used in applications where a higher voltage and a low contact resistance are required. While reed switches are more reliable than mechanical relays, it is believed that electronic switches offer the highest reliability.

A construction of an electronic switch which may be used in the present application, in place of the switch 154, is shown in FIG. 3B. As shown in FIG. 3B, control signals from the Zero Position Detector 152 are used for controlling electronic switches SW1 and SW2. SW1 should “make” when SW2 “breaks”, and vice versa. To achieve this result, a logic Inverter 170 is connected with and upstream of SW2. The switches SW1 and SW2 can be constructed of simple transistors or FETs. With common design practice, it is possible to use just one or two transistors or FETs for each switch, and reliability can be ensured.

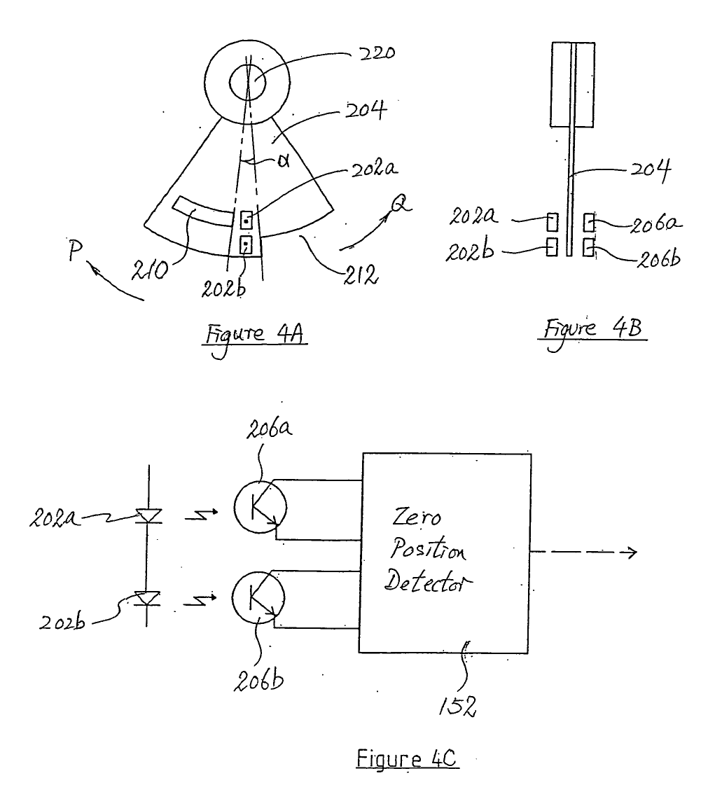

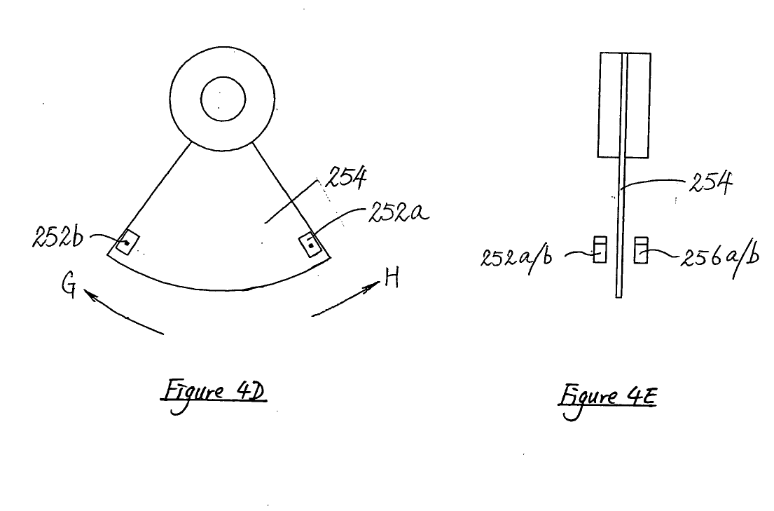

A further safety arrangement, in particular an infrared centre position detector, is shown in FIGS. 4A to 4C. Two infrared light emitting diodes (IR LEDs) 202a, 202b are arranged one above the other on a first side of the rotor 204, and two phototransistors 206a, 206b are arranged, again one above the other, on a second side of the rotor 204. In the absence of any intervening obstacles, the phototransistor 206a can detect infrared transmission from the IR LED 202a, and the phototransistor 206b can detect infrared transmission from the IR LED 202b. As shown in FIG. 4C, the signals from the phototransistors 206a, 206b are fed to the Zero Position Detector 152 (discussed above), whose output is used for controlling the switch 154, or the electronic switch shown in FIG. 3B, as discussed above.

The rotor 204 is in the shape of a sector and has an arcuate hollow slot 210 and a cut-out portion 212. When the rotor 204 is in the position as shown in FIG. 4A, or within the small dead zone angle α, infrared transmission between the IR LED 202a and the phototransistor 206a, and between the IR LED 202b and the phototransistor 206b will be blocked by the rotor 204, thus signalling a centre position.

When the rotor 204 rotates clockwise, i.e. in the direction indicated by the arrow P, while infrared transmission between the IR LED 202a and the phototransistor 206a will still be blocked, the cut-out portion 212 will allow infrared transmission emitted by the IR LED 202b to be detected by the phototransistor 206b. On the other hand, when the rotor 204 rotates anti-clockwise, i.e. in the direction indicated by the arrow Q, infrared transmission between the IR LED 202b and the phototransistor 206b will be blocked, whereas the hollow slot 210 will allow infrared transmission emitted by the IR LED 202a to be detected by the phototransistor 206a.

By way of such an arrangement, it is not only possible to determine the angular position of the rotor 204, and thus a shaft 220 to which it is secured, but also possible to detect whether the rotation is in the clockwise or the anti-clockwise direction. Such an arrangement can thus differentiate between a forward or a rearward motion, which may be important in the safe operation of an electrical wheelchair.

As an alternative to the arrangement shown in FIGS. 4A and 4B, and as shown in FIGS. 4D and 4E, two infrared light emitting diodes (IR LEDs) 252a, 252b are arranged next to each other on a first side of a rotor 254, and two phototransistors 256a, 256b are arranged, again next to each other, on a second side of the rotor 254. In the absence of any intervening obstacles, the phototransistor 256a can detect infrared transmission from the IR LED 252a, and the phototransistor 256b can detect infrared transmission from the IR LED 252b. As in the arrangement shown in FIG. 4C, the signals from the phototransistors 256a, 256b are fed to the Zero Position Detector 152 (discussed above), whose output is used for controlling the switch 154, as discussed above.

When the rotor 254 is within the small dead zone angle, infrared transmission between the IR LED 252a and the phototransistor 256a, and between the IR LED 252b and the phototransistor 256b will be blocked by the rotor 254, thus signalling a centre position.

When the rotor 254 rotates clockwise, i.e. in the direction indicated by the arrow G, while infrared transmission between the IR LED 252b and the phototransistor 256b will still be blocked, infrared transmission emitted by the IR LED 252a can be detected by the phototransistor 256a. On the other hand, when the rotor 254 rotates anti-clockwise, i.e. in the direction indicated by the arrow H, infrared transmission between the IR LED 252a and the phototransistor 256a will be blocked, whereas infrared transmission emitted by the IR LED 252b can be detected by the phototransistor 256b.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. An inductive angular sensor including a first part and a second part which are swivellably movable relative to each other, wherein said first part includes a primary coil energizable to generate a voltage and two secondary coils each on a side of said primary coil and adapted to sense the voltage generated by said primary coil, wherein a channel runs through said primary coil and said two secondary coils, wherein said second part includes a body member mounted with at least one wire member, wherein during relative swiveling movement between said first and second parts, said at least one metallic wire member reciprocates in said channel, and wherein when the angle of rotation between said first and second parts is within a pre-determined range about a pre-defined zero position, said at least one metallic wire member is out of said primary coil.

2. A sensor according to claim 1 wherein said channel is arcuate in shape.

3. A sensor according to claim 1 wherein at least one said metallic wire member is arcuate in shape.

4. A sensor according to claim 3 wherein said at least one metallic wire member is of a radius of curvature generally the same as that of the channel.

5. A sensor according to claim 1 wherein said at least one metallic wire member is made at least principally of a material of a high magnetic permeability.

6. A sensor according to claim 1 wherein said at least one metallic wire member is made at least principally of a material of a low permanence.

7. A sensor according to claim 5 wherein said at least one metallic wire member is made at least principally of soft iron or silicon iron.

8. A sensor according to claim 1 wherein said body member is mounted with a plurality of metallic wire members.

9. A sensor according to claim 8 wherein when the angle of rotation between said first and second part is within said pre-determined range, said plurality of metallic wire members are out of said primary coil.

10. A sensor according to claim 1 further including two amplifiers, each being adapted to amplify the voltage in a respective secondary coils as induced by said primary coil.

11. A sensor according to claim 1 further including a first and a second rectifiers, said first rectifier being adapted to rectify the voltage in a first of said secondary coils into a positive voltage, and said second rectifier being adapted to rectify the voltage in a second of said secondary coils into a negative voltage.

12. A sensor according to claim 11 further including an adding circuit to sum up the resultant positive and negative voltages from said rectifiers to arrive at a resultant voltage whose value varies in proportion to the angle of rotation between said first and second parts.

13. A sensing device including an angular sensor and a zero position detector, wherein said angular sensor includes a first part and a second part which are swivellably movable relative to each other, and wherein said zero position detector is adapted to have a logic level output when the angle of rotation between said first and second parts is within a pre-determined range about a pre-defined zero position.

14. A sensing device according to claim 13 wherein said angular sensor is an inductive angular sensor.

15. A sensing device according to claim 13 wherein when the angle of rotation between said first and second part is within said pre-determined range, the output of said sensing device is connected to a centre of a fixed resistor.

16. A sensing device according to claim 13 wherein when the angle of rotation between said first and second part is beyond said pre-determined range, output of said sensing device is connected to said angular sensor.

17. A sensing device according to claim 13 wherein said zero position detector includes at least a pair of radiation emitter and radiation receiver disposed each on a respective side of said second part.

18. A sensing device according to claim 17 wherein transmission of radiation between said emitter and receiver is prevented when the angle of rotation between said first and second part is within said pre-determined range.

19. A sensing device according to claim 17 wherein said radiation emitter is an infrared light emitter diode.

20. A sensing device according to claim 17 wherein said radiation receiver is a phototransistor.

21. A sensing device according to claim 17 wherein said zero position detector includes at least first and second pairs of radiation emitters and radiation receivers, wherein said radiation emitters are disposed on a first side of said second part, and wherein said radiation receivers are disposed on a second side of said second part.

22. A sensing device according to claim 21 wherein when the angle of rotation between said first and second parts is out of said pre-determined range to a first side thereof, radiation between said first pair of radiation emitter and radiation receiver is allowed and radiation between said second pair of radiation emitter and radiation receiver is prevented.

23. A sensing device according to claim 22 wherein when the angle of rotation between said first and second parts is out of said pre-determined range to a second side thereof, radiation between said first pair of radiation emitter and radiation receiver is prevented and radiation between said second pair of radiation emitter and radiation receiver is allowed.

24. A sensing device according to claim 21 wherein said second part has a first clearing which, when the angle of rotation between said first and second part is beyond said pre-determined range to a first side thereof, allows transmission of radiation between said first pair of emitter and receiver.

25. A sensing device according to claim 24 wherein said second part has a second clearing which, when the angle of rotation between said first and second part is beyond said pre-determined range to a second side thereof, allows transmission of radiation between said second pair of emitter and receiver.

26. A sensor according to claim 6 wherein said at least one metallic wire member is made at least principally of soft iron or silicon iron.
